(19) United States
(12) Patent Application Publication
(10) Pub. No.: US 2022/0397175 A1
(43) Pub. Date: Dec. 15, 2022

(54) TORSION SPRING DEVICE, BEARING, AND VIBRATION DAMPER

(71) Applicant: ROSTA AG, Hunzenschwil (CH)

(72) Inventors: Erich KRAMER, Brugg (CH); Marc MOLLENKOPF, Birsfelden (CH); Bruno MANHART, Biberstein (CH); Fabian SCHMITTER, Unterlunkhofen (CH)

(73) Assignee: ROSTA AG, Hunzenschwil (CH)

(21) Appl. No.: 17/761,621

(22) PCT Filed: Sep. 16, 2020
(86) PCT No.: PCT/EP2020/075844

§ 371 Date: Mar. 18, 2022

(30) Foreign Application Priority Data
Sep. 19, 2019 (EP) 19198412.9

(51) Int. Cl. F16F 1/54; F16F 1/373; F16F 1/38; F16F 1/50

(52) U.S. Cl. CPC F16F 1/545; F16F 1/373; F16F 1/3821; F16F 1/3863; F16F 1/505

(57) ABSTRACT

Torsion spring device includes an outer housing, an inner housing located in the outer housing, and an elastic element. The elastic element supports the inner housing relative to the outer housing such that a restoring force is built up between the outer housing and the inner housing as a result of a deflection caused when the outer housing and the inner housing are rotated relative to one another. The restoring force-deflection curve can be adjusted by a choice of shape and/or material of the outer housing, of the inner housing, and of the elastic element and/or wherein the hysteresis can be adjusted by a choice of shape and/or material of the outer housing, of the inner housing and of the elastic element.

### TECHNICAL FIELD

The present invention relates to a torsion spring device and a bearing and a vibration damper with a torsion spring device.

### PRIOR ART

A rubber spring element is known from the prior art, which contains an outer housing (e.g. a cast steel part or a steel shaped tube) and an inner housing inserted herein. Elastic rubber strands are arranged respectively in the intermediate spaces between the outer housing and the inner housing which is arranged angularly offset thereto. The elastic rubber strands support the internal housing centrally in the outer housing. With a rotating of the housings relative to one another, proceeding from a state of rest (rotating about a deflection angle), a restoring force is built up.

For example, in DE 936 835 C a torsionally elastic suspension element is described, which consists of an inner part, polygonal on the outer side, which lies concentrically in an outer part, polygonal on the inner side, of the same number of edges. The inner part and outer part are held by intercalation of the corresponding number of elastic rolls.

In DE 20 2009 010 675 U1 a rubber spring system is described, which comprises an outer housing, a square profile offset through 45° and four vibration-damping rubber bodies.

Vibration dampers, i.e. elastic bearings for vibration damping are further known, which comprise torsion springs of the described type.

Devices of the type described in the prior art are also designated as “Neidhart springs”, “Neidhart spring elements”, “Neidhart spring devices” or similar.

Devices of the type described in the prior art can be used for springing, damping and bearing.

The spring characteristics of the rubber spring elements described in the prior art are realized by the rubber bodies which receive the vibrations and, at the same time, guarantee the securing and bearing of the inner housing.

The restoring force as a function of the deflection in the form of a rotation is represented by the restoring force-deflection curve. This curve can also be designated as “force-deflection curve” or “characteristic curve” or “spring characteristic” of the torsion spring device. It corresponds to the principle according to the force-path characteristic of a spiral spring, in which the deflection is linear.

A disadvantage in the conventional rubber spring elements is that the restoring force-deflection curve for small deflections is relatively flat, however runs relatively steeply starting from a particular deflection. The transition from the flat into the steep region is typically abrupt here, i.e. the restoring force-deflection curve has a sharp bend at the transition. Sometimes the restoring force-deflection curve then runs so steeply that the further rotational movement is abruptly opposed by a very great resistance and it thus butts, in a sense, against a hard stop. On further loading, the rubber bodies can become overstretched and thereby damaged.

Through the steep course with greater deflections, the range of use of the conventional rubber spring elements is limited, so that these can not be used as torsion spring elements for applications in which greater deflections occur.

A disadvantage in the conventional rubber spring elements is, furthermore, that the possible deflection is limited to rotation angles of typically 30° starting from the position of rest. A disadvantage in the conventional rubber spring elements is, furthermore, that their shape is typically limited by the shape of the square profiles which are to be used for their housings. Furthermore, a disadvantage in the conventional rubber spring elements is their typically high weight. Furthermore, conventional rubber spring elements are miniaturised with difficulty. As they typically comprise several further parts in addition to the housing, their production is, moreover, relatively complicated, as the parts have to be assembled. Moreover, conventional rubber spring elements—in particular owing to the construction from several individual parts—are typically not able to be used in the field of food production.

### SUMMARY OF THE INVENTION

A problem forming the basis of the present invention consists in preventing one or more of the named disadvantages, and of providing an improved torsion spring device, an improved bearing and an improved vibration damper.

This problem is solved by a torsion spring device according to claim 1 or a torsion spring device according to claim 2, the bearing according to claim 19 and the vibration damper according to claim 20. Further developments of the invention are indicated in the subclaims. The features named in the subclaims to the torsion spring device and the features relating to torsion spring device mentioned further below in the description can also be understood as a further development of the bearing according to the invention and of the vibration damper according to the invention and vice versa.

The torsion spring device according to the invention in accordance with a first aspect of the invention comprises an outer housing, an inner housing arranged in the outer housing, and an elastic element which supports the inner housing relative to the outer housing, so that a restoring force is built up between the outer housing and the inner housing as a result of a deflection caused when the outer housing and the inner housing are rotated relative to one another, wherein
the restoring force-deflection curve can be adjusted by a choice of shape and/or material of the outer housing, of the inner housing and of the elastic element and/or wherein the hysteresis can be adjusted by a choice of shape and/or material of the outer housing, of the inner housing and of the elastic element.

A torsion spring device is understood to mean a device in which a restoring force is built up through a deflection from a position of rest in the form of a rotation. The restoring force as a function of the deflection corresponds to the restoring force-deflection curve.

“Hysteresis” is understood to mean the hysteresis of the elastic behaviour of the torsion spring device, i.e. the hysteresis of the restoring force-deflection curve.

According to the invention, the elastic behaviour (restoring force-deflection relation and/or hysteresis) can be accordingly adjusted or respectively adapted, for example so that the restoring force-deflection curve is flat or steep or respectively symmetrical (in particular linear) or asymmetrical (for example linear with deflections in the one rotation direction and progressive with deflections in the other rotation direction), or so that a strong or weak damping effect is produced. A high damping effect is desired for example in applications for impact protection, in which high impact energies occur. According to the invention, the elastic behaviour can be adapted to the requirements of the respective application.

In particular, according to the invention for example it can be prevented that in the case of strong deflections (rotational movements in which large rotation angles are covered), too high a restoring force is built up and a springing or damping in the case of large deflections is no longer satisfactorily possible. The torsion spring device according to the invention is therefore suitable for applications in which intensive deflections occur, because the object which is to be sprung or damped (for example a vibrating machine or a vibrating suspension) is also reliably and effectively sprung or respectively damped in the case of intensive deflections (vibrations with high amplitude). In this way, for example, strong impacts can also be damped reliably. Furthermore, it can be prevented for example that the elastic elements of the torsion spring device are overstretched and thereby damaged owing to restoring forces which are too high. Through a reliable and effective springing or damping in the case of intensive deflections (vibrations), damage to the sprung or respectively damped object can also be reduced. Moreover, objects and persons situated in the region of this object are protected from hard shaking—or impact movements.

The torsion spring device according to the invention in accordance with a second aspect of the invention comprises an outer housing, an inner housing arranged in the outer housing, and an elastic element which supports the inner housing relative to the outer housing so that a restoring force is built up between the outer housing and the inner housing as a result of a deflection caused when the outer housing and the inner housing are rotated relative to one another, wherein the elastic element is formed in one piece.

Thereby, it can be possible for example that the elastic behaviour of the torsion spring device can be adapted. Furthermore, for example the production of the torsion spring device can be simplified thereby. Moreover, for example a miniaturising of the torsion spring device can thereby be possible.

The outer housing preferably consists at least partially of at least one plastic material, wherein the plastic material comprises more preferably at least one copolyester, wherein the copolyester still more preferably is a thermoplastic copolyester, wherein the copolyester is most preferably a low-melting thermoplastic copolyester. Particularly preferably, the outer housing consists of Tritan® 1501 and/or PA12-GF20 and/or PTB-GF 50.

The inner housing preferably consists at least partially of at least one plastic material, wherein the plastic material comprises more preferably at least one copolyester, wherein the copolyester still more preferably is a thermoplastic copolyester, wherein the copolyester is most preferably a low-melting thermoplastic copolyester. Particularly preferably, the inner housing consists of Tritan® 1501 and/or PA12-GF50 and/or PTB-GF 50.

The outer housing and inner housing can comprise the same material or different materials.

Preferably, the elastic element comprises an elastic material, more preferably an elastomer, wherein the elastomer is still more preferably a radiation-crosslinkable elastomer, in particular TPE-E.

Through a corresponding choice of the materials for the outer housing, the inner housing and/or the elastic element, for example the adapting of the elastic behaviour of the torsion spring device can be achieved in a preferred manner. For example in particular low-melting thermoplastics can have a good vibration connection with the elastic element. Furthermore, for example materials can be used which owing to their composition are suitable for the respective field of application, for example materials which meet the specific material requirements of the food industry with regard to non-toxicity, hygiene, cleanability etc. Furthermore, for example materials can be used which permit a miniaturising of the torsion spring device and/or produce a light torsion spring device.

Preferably, the materials are selected so that the elastic element can merge well with the inner housing and/or with the outer housing, so that a good adhesion results. For that, it is advantageous if low-melting materials are used for the inner housing and the outer housing. Furthermore, it is preferred that the material of the elastic element is radiation-crosslinkable; thereby, for example, its behaviour can be approximated to the behaviour of caoutchouc. TPE is particularly preferred as material for the elastic element owing to its fusibility, in particular when low-melting plastic materials are used for the outer housing and the inner housing.

Preferably, a first region of the elastic element at least partially lines the outer housing at its inner surfaces, while a second region of the elastic element at least partially encases the inner housing at its outer surfaces and wherein a third region of the elastic material in the form of webs is arranged between the first and the second region of the elastic material. Further preferably, the webs are formed as continuous strands and/or are arranged helically. Further preferably, the webs extend from the region of the inner edges of the outer housing to the region of the outer surfaces of the inner housing.

The elastic element is preferably fused with the outer housing and the inner housing, wherein optionally, to assist adhesion, undercuts are provided on the outer housing and/or on the inner housing. Thereby, for example, the torsion spring device can be produced in a simple manner.

The outer housing is preferably a hollow polygonal profile with open ends, wherein the polygonal profile more preferably has a polygonal, n-sided cross-section, wherein n is selected more preferably from the group consisting of 3, 4 and 6, wherein n is most preferably 4.

The inner housing is preferably a polygonal profile arranged in the interior of the outer housing, wherein the polygonal profile more preferably has a polygonal, n-sided cross-section, wherein n is selected still more preferably from the group consisting of 3, 4 and 6, wherein n is most preferably 4.

n can have the same value for the outer housing and the inner housing, and the outer housing and the inner housing can be angularly offset to one another in particular through 180°/n with respect to a shared longitudinal axis.

Through a corresponding choice of the geometry of the outer housing, of the inner housing and/or of the elastic element, for example the adapting of the elastic behaviour of the torsion spring device can be achieved in preferred manner.

Preferably, the inner housing has at least one through-bore and/or a through-hole and/or blind holes for the connection of the inner housing with a component not belonging to the torsion spring device. Thereby for example a connection can be achieved between this component and the inner housing in a simple manner.

Preferably, the torsion spring device is produced by means of an injection moulding process. Thereby for example it can be prevented that the components have to be produced individually and subsequently assembled in an additional step.

The bearing according to the invention comprises at least one torsion spring device according to the invention.

The vibration damper according to the invention comprises at least one torsion spring device according to the invention.

### BRIEF DESCRIPTION OF THE DRAWINGS

Further details and expediencies of the invention and in particular example embodiments of the torsion spring device according to the invention, of the bearing according to the invention and of the vibration damper according to the invention are described below with reference to the enclosed drawings. The individual features of the embodiments can, in so far as expedient, be combined with one another in any desired manner.

FIG. 1 shows a schematic oblique view of a torsion spring device according to a first embodiment of the present invention.

FIG. 2 shows a schematic side view of the torsion spring device according to the first embodiment.

FIG. 3 shows a stress distribution (FEM simulation) of an elastic element of the torsion spring device according to the first embodiment.

FIG. 4 shows a schematic oblique view of the torsion spring device according to a second embodiment.

FIG. 5 shows a schematic oblique view of the torsion spring device according to a third embodiment.

FIG. 6 shows a schematic oblique view of the torsion spring device according to a fourth embodiment.

FIG. 7 shows a schematic oblique view of the torsion spring device according to a fifth embodiment.

FIG. 8 shows a schematic oblique view of the torsion spring device according to a sixth embodiment.

FIG. 9 shows a schematic oblique view of the torsion spring device according to a seventh embodiment.

FIG. 10 shows a schematic side view of a bearing according to an eighth embodiment.

FIG. 11 shows a schematic side view of a vibration damper according to a ninth embodiment.

FIG. 12 shows a schematic side view of a vibration damper according to a tenth embodiment.

### DESCRIPTION OF EMBODIMENTS

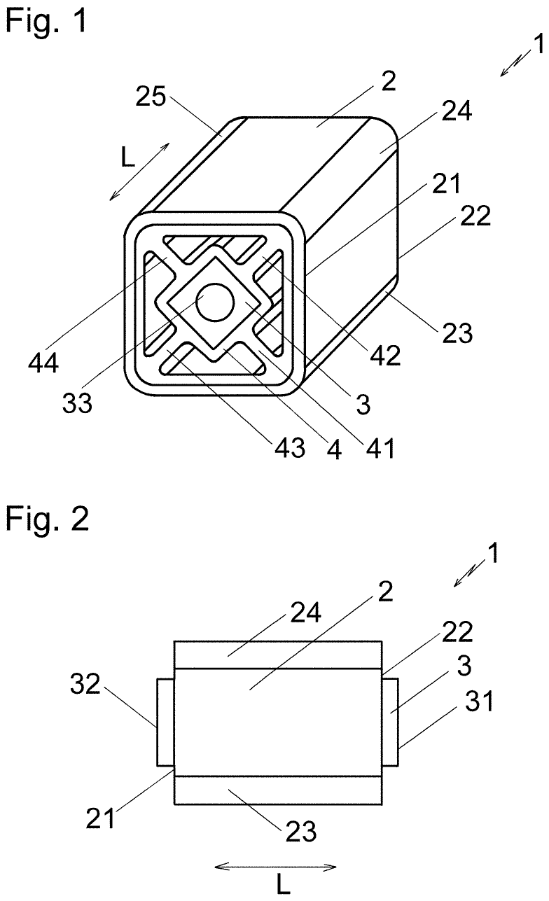

In FIG. 1 an oblique view is illustrated of a torsion spring device 1 according to a first embodiment of the present invention. FIG. 2 shows the torsion spring device 1 according to the first embodiment from the side.

The torsion spring device 1 comprises an outer housing 2. The outer housing 2 preferably consists of a plastic material, preferably of a highly resilient plastic material, in particular a material on the basis of copolyesters. According to a practical embodiment of the invention, the outer housing 2 consists at least substantially of the thermoplastic copolyester with the trade name Tritan® 1501. In alternative embodiments, the outer housing 2 consists at least substantially of a low-melting thermoplastic, for example of PA12-GF50 or PTB-GF 50.

In an alternative embodiment, the outer housing 2 consists for example of a metallic material. For example, the outer housing can be embodied as a cast steel component. Furthermore, it is possible that the outer housing 2 consists of a combination of one or more plastics and/or of one or more metals or of another material combination.

The outer housing 2 can be provided with a particular colour on its outer side, for example by painting or coating. Preferably, however, a plastic material with a particular colour can be used for the outer housing, in order to give it this colour.

According to the present embodiment, the outer housing 2 concerns a square profile with open ends 21, 22, which is hollow along its longitudinal extent L (longitudinal direction). The edges 25, 26, 25, 26 parallel to the longitudinal extent L (“longitudinal edges” in the following) are optionally rounded on the inner side (inner edge) and/or on the outer side (outer edge). In alternative embodiments, the outer housing 2 can also be embodied for example as a hollow body with three edges, with more than four edges, with a circular, oval or differently shaped cross-section, wherein any edges on the inner side and/or on the outer side can be rounded.

In preferred embodiments, the longitudinal edges of the outer housing 2 have a length of 1 mm to 500 mm, and the edges transversely thereto have a length of 1 mm to 100 mm.

The torsion spring device 1 further comprises an inner housing 3. The inner housing 3 preferably consists of a plastic material, preferably of a highly resilient plastic material, in particular a material on the basis of copolyesters. According to a practical embodiment of the invention, the inner housing 3 consists at least substantially of the thermoplastic copolyester with the trade name Tritan® 1501. In alternative embodiments, the inner housing 3 consists at least substantially of a low-melting thermoplastic, for example of PA12-GF50 or PTB-GF 50. The outer housing 2 and the inner housing 3 can consist of the same material or of different materials. For the inner housing 3, a different material from the plastic material of the outer housing 2 can be used. In an alternative embodiment, the inner housing 3 consists for example of a metallic material. Furthermore, it is possible that the outer housing 2 consists of a combination of one or more plastics and/or one or more metals or of another material combination. If, for example, the outer housing 2 is constructed substantially from a metallic material, it is advantageous to anchor the elastic element (see below) to the outer housing 2 in an undercut manner.

According to the present invention, the inner housing 3 concerns a square profile. The edges are optionally rounded. In alternative embodiments, the inner housing 2 can also have, for example three edges or more than four edges or can be embodied with a circular, oval or differently shaped cross-section, wherein any edges can be rounded.

The inner housing 3 is arranged in the outer housing 2. The ends of the inner housing 3 preferably project here out from the outer housing 2, as illustrated in FIG. 2, whereby for example the fastening of components not belonging to the torsion spring device 1 (for example components of a machine which is to be sprung or damped) is simplified.

According to the present embodiment, the inner housing 3 has a round through-bore 33, which extends parallel to the edges of the inner housing 3 (“longitudinal edges” in the following) running in longitudinal direction L. The through-bore 33 serves for connection of the inner housing 3 with a shaft, a rod or with pins (not component parts of the torsion spring device 1; not illustrated in the figures), wherein the shaft or rod is directed through the through-bore 33 or respectively the pins are introduced into the through-bore 33. In alternative embodiments, instead of a through-bore 33, a blind bore can be provided for example on each of the two end faces of the inner housing 3. Optionally, it is possible that the through-bore 33 is provided at least in its opening regions with an internal thread or with another fastening structure. The said blind bores can also be provided for this purpose respectively with a thread or with another fastening structure. In alternative embodiments, instead of a round through-bore 33 or round blind bores, differently shaped holes (through-holes or blind holes), for example holes with a polygonal cross-section are provided. The holes serve here likewise for connection of the inner housing 3 with a component not belonging to the torsion spring device 1, such as for example a component of a machine.

According to the present embodiment, the outer housing 2 and the inner housing 3 have cross-section shapes corresponding to one another, as respectively square profiles are concerned. In alternative embodiments, outer housing 2 and inner housing 3 can have different shapes, for example a square inner housing can be inserted into a round outer housing.

According to the present embodiment, the inner housing 3 is arranged in the outer housing 2 so that in the position of rest illustrated in FIG. 1 (deflection=0 and hence restoring force=0), the longitudinal edges of the inner housing 3 lie opposite the centre lines between the longitudinal edges of the outer housing 2. This means that when the outer housing 2 and the inner housing 3 are polygonal profiles with n-sided cross-section, the inner housing 3 and the outer housing 2 are angularly offset by 180°/n with respect to one another. According to the present embodiment, inner housing 3 and outer housing 2 are accordingly angularly offset by 45° with respect to one another.

The torsion spring device 1 further comprises an elastic element 4. The elastic element 4 supports the inner housing 3 preferably centrally in the outer housing 2. On a rotating of the inner housing 2 and of the outer housing 3 relative to one another, proceeding from a position of rest, i.e. on a rotating about a deflection angle, a restoring force is built up. In alternative embodiments, the elastic element is supported eccentrically in the outer housing 2; also in these embodiments, on the rotating of the inner housing 2 and of the outer housing 3 relative to one another, proceeding from a position of rest, a restoring force is built up.

The elastic element 4 at least partially lines the outer housing 2 on the inner surfaces lying parallel to the longitudinal extent L, and at least partially encases the inner housing 3 on the outer surfaces lying parallel to the longitudinal extent L. Between the region of the elastic material 4, which lines the outer housing 2, and the region of the elastic material 4, which encases the inner housing 3, the elastic material 4 is arranged in the form of webs 41, 42, 43, 44. The webs 41, 42, 43, 44 can extend over the entire length of the outer housing 2 in the direction L or only over a portion of this length. The webs 41, 42, 43, 44 can be formed as continuous strands running in direction L, or can have interruptions. According to the present embodiment, the webs 41, 42, 43, 44 connect the region of the inner edges of the outer housing 2 with the region of the outer surfaces of the inner housing 3. In alternative embodiments, the webs 41, 42, 43, 44 can for example also connect the region of the longitudinal edges of the inner housing 3 with the region of the inner surfaces of the outer housing 2. In alternative embodiments of the invention, the webs can be arranged asymmetrically and/or helically. Thereby, for example, an asymmetric characteristic can be achieved.

The elastic element 4 is preferably merged with the outer housing 2 and the inner housing 3, i.e. the elastic element 4 enters respectively into a connection with the outer housing 2 and with the inner housing 3. This merging can be achieved for example through the application of an injection moulding process for the production of the torsion spring device 1. Optionally, for adhesion assistance, undercuts can provide for an additional anchoring. It is not intended that the different components have to be assembled individually.

The elastic element 4 consists at least partially of an elastic material, preferably an elastomer, in particular a radiation-crosslinkable elastomer such as TPE-E for example.

According to the present embodiment, the elastic element 4 is formed in one piece. According to alternative embodiments, the elastic element 4 can also be composed of different parts, wherein different parts can consist of the same material or of different materials, wherein a sufficient adhesion of the elastic element 4 to outer housing 3 and inner housing 3 is present.

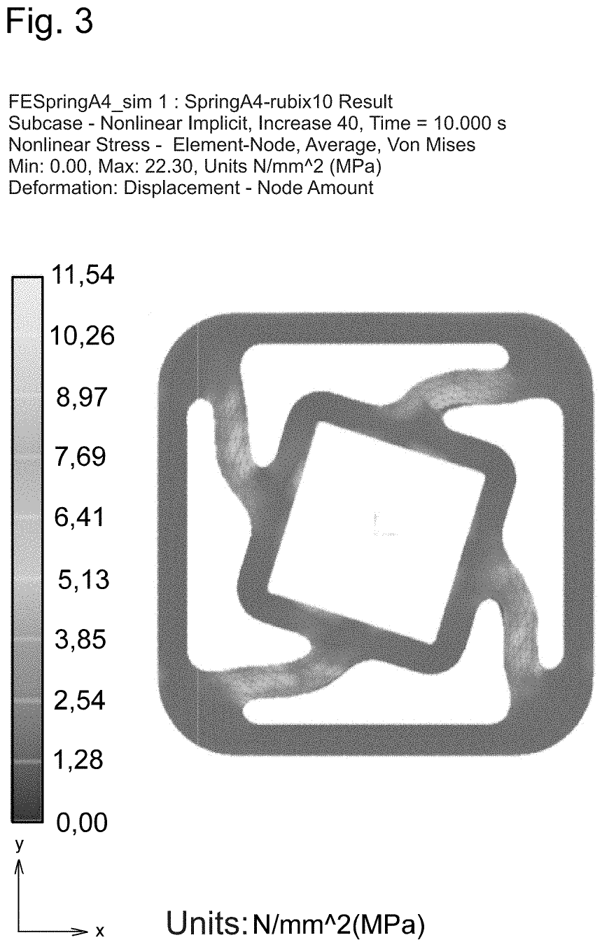

As a practical example, in FIG. 3 the stress distribution, obtained by means of FEM simulation (simulation by means of the finite element method) of the elastic element 4 of a torsion spring device 1 according to the first embodiment is represented, wherein the torsion spring device 1 is deflected by rotating of the outer housing 2 and of the inner housing 3 relative to one another. In the stress distribution in FIG. 3, high stress values lie in the light regions and low stress values lie in the dark regions.

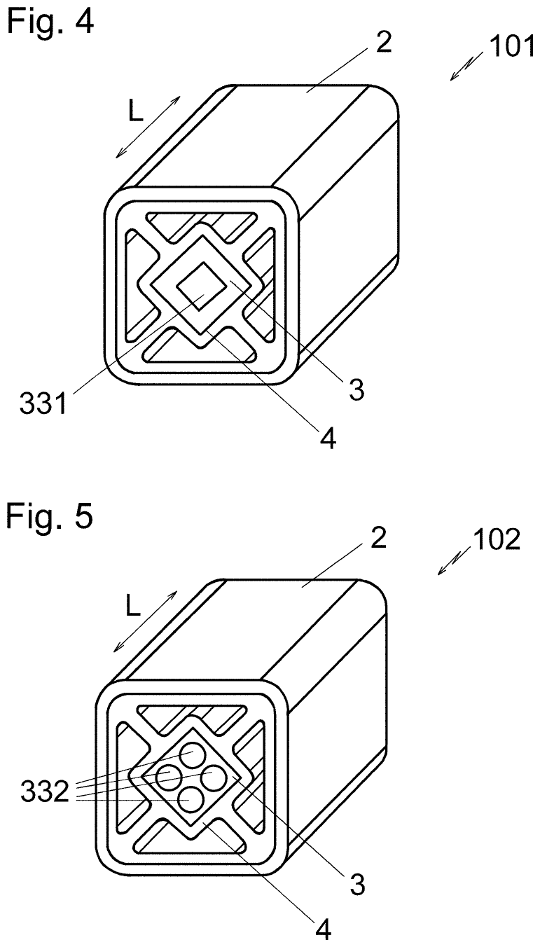

In FIG. 4 a torsion spring device 101 according to a second embodiment of the invention is presented in oblique view. Elements of the present embodiment which correspond to those of the first embodiment, are provided with the same reference numbers.

The torsion spring device 101 according to the second embodiment differs from the torsion spring device 1 of the first embodiment in that according to the second embodiment a through-hole 311 or blind holes 331 with a rectangular, preferably square cross-section are let into the inner housing 3. Thereby, it is possible for example to connect a rectangular shaft with the inner housing 3 in a manner which is simple and secured against rotating. In alternative embodiments, through-holes or blind holes with a cross-section having three sides or with more than three sides or with a different cross-section are possible.

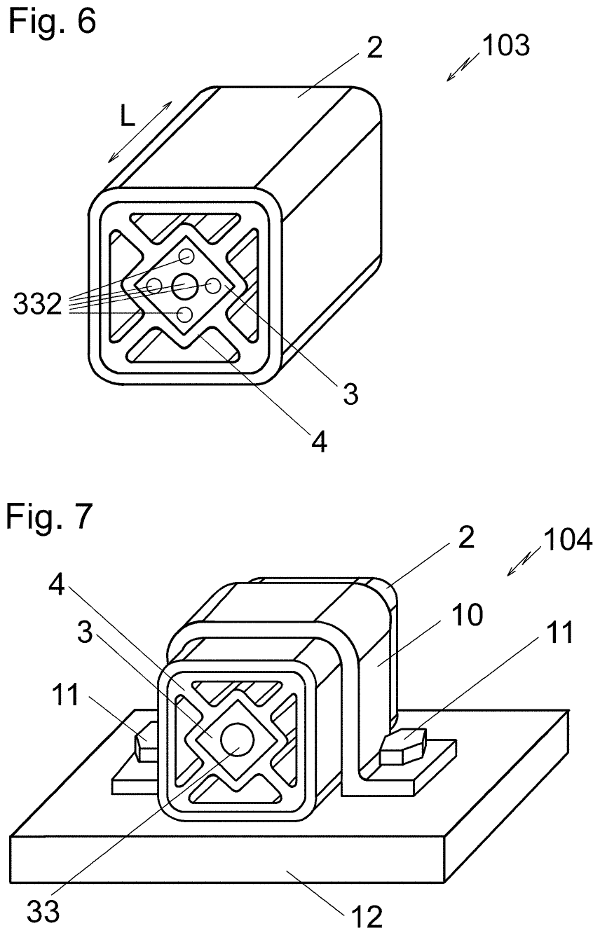

In FIG. 5 a torsion spring deice 102 according to a third embodiment of the invention is illustrated in oblique view. In FIG. 6 a torsion spring device 103 according to a fourth embodiment of the invention is illustrated in oblique view. Elements of the present embodiments which correspond to those of the embodiments described above are provided with the same reference numbers.

The torsion spring devices 12, 13 according to the third and fourth embodiment differ from the torsion spring devices 1, 11 according to the embodiments described above in that according to the third and fourth embodiment several parallel through-holes and/or blind holes 312 are let into the inner housing 3. The cross-section shapes illustrated in FIGS. 5 and 6 and arrangements of the through-holes and/or blind holes 332 are only by way of example here. Therefore two, three or more than five through-holes and/or blind holes 332 can also be provided. The through-holes and/or blind holes 332 can be arranged symmetrically or asymmetrically. Several through-holes and/or blind holes 332 make it possible, for example, to connect components not belonging to the torsion spring device 1 (for example components of a machine which is to be sprung or damped) with the inner housing 3 in a manner which is simple and is secured against rotation.

In FIG. 7 a torsion spring device 104 according to a fifth embodiment of the invention is illustrated. Elements of the present embodiment which correspond to those of the embodiments described above are provided with the same reference numbers. The torsion spring device 104 according to the fifth embodiment comprises a fastening bridge 10 embracing the outer housing 2, which fastening bridge can be fastened to a base 12 by fastening elements 11. The fastening elements 11 and the base 12 are not considered as component parts of the torsion spring device 104. The fastening elements 11 can be screws or rivets, for example. The base 12 can be, for example, a floor, a fixedly attached mount, a fixedly attached carrier or a component of a machine which is to be sprung or damped. The structure and the function of the outer housing 2, of the inner housing 3 and of the elastic element 4 correspond to the structure and the function according to one of the embodiments described above. In particular, the configuration illustrated in FIG. 7 with a through-hole is only by way of example.

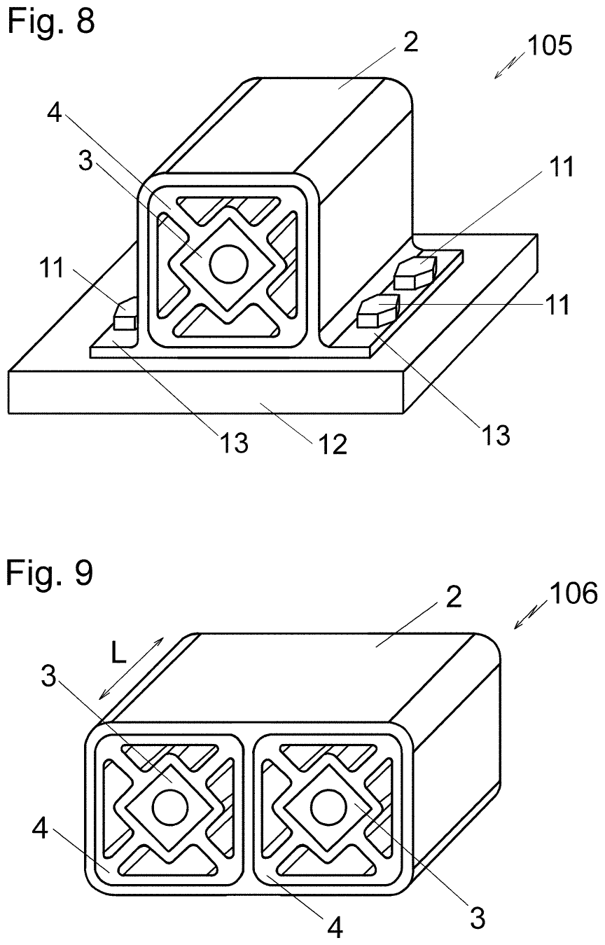

In FIG. 8 a torsion spring device 105 according to a sixth embodiment of the invention is illustrated. Instead of the fastening bridge 10 of the fifth embodiment, this comprises fastening projections 13 which are attached to the outer housing 2 so that the outer housing 2 can be fastened to the base 12 with fastening elements 11.

In alternative embodiments, the fastening of the outer housing 2 can be fastened on the base 12 for example by a clamping fist or another clamping device, plug connections, threaded eyelets provided on the outer housing 2, flanges, or by lever arms securely connected to the outer housing 2.

The connection of the inner housing 3 to a component not belonging to the torsion spring device 1, such as for example a component of a machine or a base 12, can take place in the embodiments described above for example by screw connections, plug connections, clamping connections or flange connections.

In FIG. 9 a torsion spring device 106 according to a seventh embodiment of the invention is illustrated. Elements of the present embodiment which correspond to those of the embodiments described above are provided with the same reference numbers. The torsion spring device 106 according to the fifth embodiment has an outer housing 2 and two inner housings 3. The inner housings 3 are arranged in the outer housing 2 parallel to the longitudinal direction L. The torsion spring device 106 according to the present embodiment further comprises two elastic elements 4. Each of the elastic elements 4 supports one of the inner housings 3 in the outer housing 2. The torsion spring device 106 according to the present embodiment therefore corresponds, compared to the embodiments described above, to a double torsion spring device or respectively to a torsion spring device connected in parallel. Alternatively, it is possible that both inner housings 3 are supported by a single correspondingly shaped elastic element. The torsion spring device 106 according to the present embodiment is suitable in an advantageous manner for the production of a vibration damper. In alternative embodiments, also more than two inner housings 3 can be arranged in the outer housing 2 and can be supported by one or more elastic elements 4.

The torsion spring devices according to one of the embodiments described above can be used for example in order to provide a sprung bearing. The sprung bearing can be, for example a pendulum bearing. For example, a motor or a machine can be supported resiliently with the sprung pendulum bearing, which is advantageous in particular in the case of unbalance motors and vibrators.

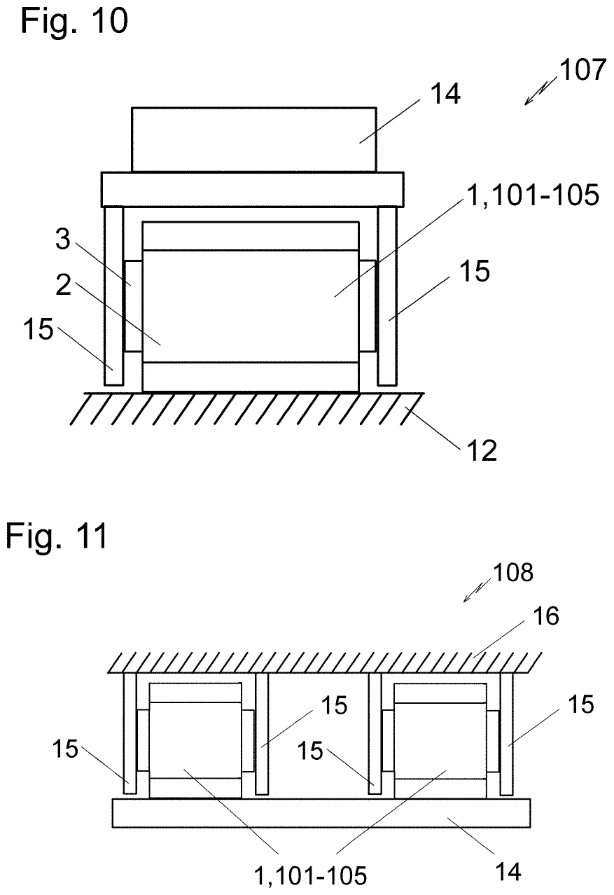

In FIG. 10 a bearing 107 for an object 14, to be supported resiliently, is illustrated according to an eighth embodiment of the invention. The bearing comprises a torsion spring device 1, 101-105. The object 14 is connected to the inner housing 3 via a suspension 15, wherein this connection is preferably rigid. The outer housing 2 is connected to a fixed base 12, for example a floor. On a deflection by a rotating of the outer housing 2 and of the inner housing 3 relative to one another, a restoring force is built up. It brings about a resilient bearing of the object 14.

In alternative embodiments of the invention, the bearing can also be constructed in a reverse manner, by the object 14 being connected to the outer housing 2 and the base 12 being connected to the inner housing 3.

In FIG. 11 a vibration damper 108 for the vibration-damped supporting of an object 14 is illustrated according to a ninth embodiment of the invention. The vibration damper comprises several torsion spring devices 1, 101-105 as vibration dampers. The inner housings 3 of the torsion spring devices 1, 101-105 are connected via suspensions 15 to a ceiling 16, a fixedly arranged carrier 16 or similar. The object 14 is connected to the outer housings 3 of the torsion spring devices 1, 101-105. On a deflection by a rotating of the outer housing 2 and of the inner housing 3 relative to one another as a result of an oscillation of the object 14, restoring forces are built up. These bring about a vibration damping.

In alternative embodiments of the invention, the vibration damper 108 can also be constructed in a reverse manner, in which the object 14 is connected to the inner housings 3 and the ceiling 16 or the carrier 16 is connected to the outer housings 2.

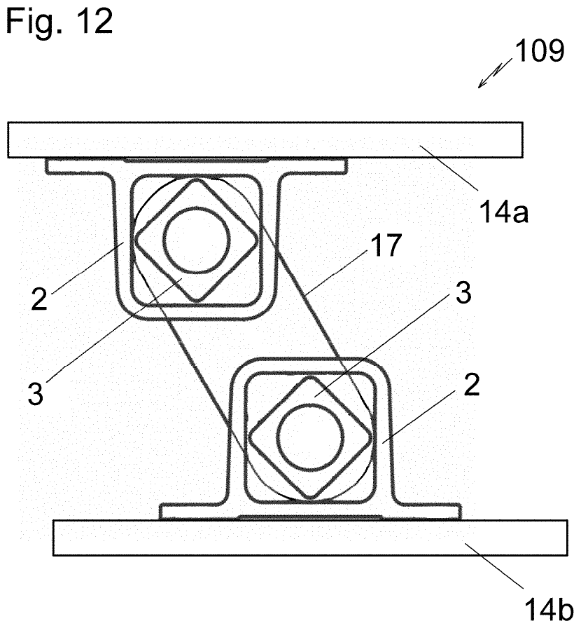

In FIG. 12 a vibration damper 109 for the vibration-damped supporting of two objects 14a, 14b relative to one another is illustrated according to a tenth embodiment of the invention. The objects 14a, 14b are respectively connected to the outer housing 2 of a torsion spring device 1, 101-105. One of the objects 14a, 14b can also be a ceiling, a floor, a fixedly arranged carrier or similar. The inner housings 3 of the torsion spring devices 1, 101-105 are rigidly connected to one another for example by a plate 17. On deflections by a rotating of the outer housings 2 and of the inner housings 3 relative to one another as a result of oscillations of the objects 14a, 14b, restoring forces are built up. These bring about a vibration damping. The elastic elements 4 of the torsion spring devices 1, 101-105 are not illustrated in FIG. 12.

In alternative embodiments of the invention, a vibration damper for the vibration-damped supporting of two objects relative to one another can also comprise a torsion spring device with an outer housing 2 and several inner housings 3, for example a torsion spring device 106 according to the seventh embodiment of the invention. The objects which are to be supported in a vibration-damped manner are respectively connected to one of the inner housings 3 via suspensions. On deflections by a rotating of the outer housing 2 and of the inner housings 3 relative to one another as a result of oscillations of the objects which are to be supported in a vibration-damped manner, restoring forces are built up. These bring about a vibration damping.

Further application examples for bearings and vibration dampers using the torsion spring device according to the invention exist inter alia in shock absorbers, in the supporting of a mixer arm, for example a concrete mixer, in the supporting of pressure rollers, in spring joints, in the supporting of belt scrapers, in pendulum joints, in stop buffers and impact plates, in crane suspensions, in vibration isolation, for example the vibration isolation of a switch box, in the supporting of belt tensioners and chain tensioners, in independent wheel suspensions, in gondola bearings, in pivoting motor bases, in the supporting and/or vibration damping of vibratory conveying troughs and guide rails, in spring elements of catches, in support roller suspensions, in baby carriage suspensions, baby bouncers, in robotics, in spring elements of gripper arms, in the supporting of track tamping devices, in the food industry.

Through the choice of suitable materials for the outer housing 2, the inner housing 3 and the elastic element 4 and/or through the choice of a suitable geometry of the outer housing 2, of the inner housing 3 and of the elastic element 4, the restoring force-deflection curve and the hysteresis of the torsion spring device according to the invention, of the bearing according to the invention and of the vibration damper according to the invention can be adapted to the respective application.

1. A torsion spring device (1, 101-106) comprising
an outer housing (2),
an inner housing (3) arranged in the outer housing (2) and
an elastic element (4), which supports the inner housing (3) relative to the outer housing (3) such that a restoring force is built up between the outer housing (2) and the inner housing (3) as a result of a deflection caused when the outer housing (2) and the inner housing (3) are rotated relative to one another,
wherein
the restoring force-deflection curve can be adjusted by a choice of shape and/or material of the outer housing (2), of the inner housing (3) and of the elastic element (4) and/or wherein the hysteresis can be adjusted by a choice of shape and/or material of the outer housing (2), of the inner housing (3) and of the elastic element (4)
wherein
the outer housing (2) comprises at least partially at least one plastic material.

2. A torsion spring device (1, 101-106) comprising
an outer housing (2),
an inner housing (3) arranged in the outer housing (2) and
an elastic element (4), which supports the inner housing (3) relative to the outer housing (3) such that a restoring force is built up between the outer housing (2) and the inner housing (3) as a result of a deflection caused when the outer housing (2) and the inner housing (3) are rotated relative to one another,
wherein the elastic element (4) is formed in one piece,
wherein the outer housing (2) comprises at least partially at least one plastic material.

3. The torsion spring device (1, 101-106) according to claim 1, wherein the plastic material of the outer housing (2) comprises at least one copolyester.

4. The torsion spring device (1, 101-106) according to claim 1, wherein the copolyester is a thermoplastic copolyester, which is preferably a low-melting thermoplastic copolyester.

5. The torsion spring device (1, 101-106) according to claim 1, wherein the inner housing (2) comprises at least partially of at least one plastic material.

6. The torsion spring device (1, 101-106) according to claim 1, wherein the plastic material of the inner housing (3) comprises at least one copolyester, which is preferably a thermoplastic copolyester, which is more preferably a low-melting thermoplastic copolyester.

7. The torsion spring device (1, 101-106) according to claim 1, wherein the outer housing (2) and the inner housing (3) comprise the same material, preferably the same plastic material.

8. The torsion spring device (1, 101-106) according to claim 1, wherein the outer housing (2) and the inner housing (3) comprise different materials, preferably different plastic materials.

9. The torsion spring device (1, 101-106) according to claim 1, wherein the elastic element (4) comprises an elastic material, preferably an elastomer, wherein further preferably the elastomer is a radiation-crosslinkable elastomer, most preferably TPE-E.

10. The torsion spring device (1, 101-106) according to claim 1, wherein a first region of the elastic element (4) at least partially lines the outer housing (2) on its inner surfaces, wherein a second region of the elastic element (4) at least partially encases the inner housing (3) on its outer surfaces, and wherein between the first and the second region of the elastic material (4) a third region of the elastic material (4) in the form of webs (41, 42, 43, 44) is arranged.

11. The torsion spring device (1, 101-106) according to claim 1, wherein the webs (41, 42, 43, 44) are formed as continuous strands and/or wherein the webs are arranged helically.

12. The torsion spring device (1, 101-106) according to claim 10, wherein the webs (41, 42, 43, 44) extend from the region of the inner edges of the outer housing (2) to the region of the outer surfaces of the inner housing (3).

13. The torsion spring device (1, 101-106) according to claim 1, wherein the elastic element is merged with the outer housing and the inner housing, wherein optionally for adhesion assistance undercuts are provided on the outer housing and/or on the inner housing.

14. The torsion spring device (1, 101-106) according to claim 1, wherein the outer housing (2) concerns a hollow polygonal profile with open ends (21, 22), wherein the polygonal profile preferably has a polygonal, n-sided cross-section, wherein n is more preferably selected from the group consisting of 3, 4 and 6, wherein n is still more preferably 4.

15. The torsion spring device (1, 101-106) according to claim 1, wherein the inner housing (3) concerns a polygonal profile arranged in the interior of the outer housing (2), wherein the polygonal profile preferably has a polygonal, n-sided cross-section, wherein more preferably n is selected from the group consisting of 3, 4 and 6, wherein n is still more preferably 4.

16. The torsion spring device claim (1, 101-106) according to claim 14, wherein the outer housing (2) and the inner housing (3) are polygonal profiles with respectively polygonal, n-sided cross-section, wherein n has the same value for the outer housing (2) and the inner housing (3), and wherein the outer housing (2) and the inner housing (3) are preferably angularly offset to one another by 180°/n with respect to a shared longitudinal axis.

17. The torsion spring device (1, 101-106) according to claim 1, wherein the inner housing (3) has at least one through-bore (33, 332) and/or a through-hole (331, 332) and/or blind holes (33, 331, 332) for connecting the inner housing (3) to a component not belonging to the torsion spring device.

18. The torsion spring device (1, 101-106) according to claim 1, wherein the torsion spring device (1, 101-106) is produced by means of an injection molding process.

19. A bearing (107) for an object (14), which is to be resiliently supported, comprising at least one torsion spring device (1, 101-106) according to claim 1.

20. A vibration damper (108) for the vibration-damped supporting of one or more objects (14, 14a, 14b) comprising at least one torsion spring device (1, 101-106), preferably at least two torsion spring devices (1, 101-106) according to claim 1.
